(19) United States
(12) Patent Application Publication
(10) Pub. No.: US 2005/0207179 A1
(43) Pub. Date: Sep. 22, 2005

(54) Identified structure of a controlling bulb and a normal bulb

(76) Inventor: Wun-Fang Pan, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/801,706

(22) Filed: Mar. 17, 2004

(51) Int. Cl. F21L 4/00

(52) U.S. Cl. 362/654; 362/658

(57) ABSTRACT

The present invention relates to an identified structure of a controlling bulb and a normal bulb of a decorative light string. The controlling bulb can be easily identified from a normal bulb. And the controlling connecting with a holder can and only can be received in a relating socket for corrective connection of the light string.

### BACKGROUND OF THE INVENTION

A conventional decorative light string is provided with several controlling bulbs between the normal bulbs for obtaining twinkling effect. The controlling bulb can control the normal bulb to twinkle randomly. In assembling the bulb on the light string, the controlling bulb must be connected at a right position. The known controlling bulb has a same outlook as the normal bulb. It is somehow different to identify a controlling bulb from a normal bulb. The worker is very trouble when he is assembling the bulb. If the controlling bulb were connected at a wrong position, the light string would be unavailable for use.

The present invention is to provide an identified structure of a controlling bulb and a normal bulb of a decorative light string, wherein the controlling bulb can be identified from a normal bulb. And the controlling bulb can and only can connect with relating controlling socket at its right position on the light string.

### BRIEF DESCRIPTION OF THE DRAWINGS

The following drawings indicate the character and improvement of the present invention.

FIG. 1 is an exploded perspective view showing a normal bulb and its relating holder and socket according to the present invention.

FIG. 2 is an exploded perspective view showing a controlling bulb and its relating holder and socket according to the present invention.

### DETAILED DESCRIPTION OF THE INVENTION

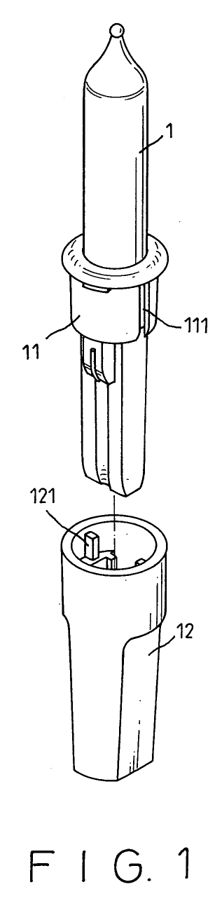

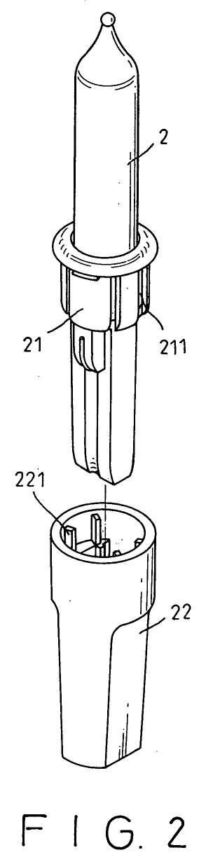

Referring to FIG. 1 and 2, they show respectively a normal bulb (1) and a controlling bulb (2). The normal bulb (1) is received in a holder (11) having two side grooves (111). A socket (12) having two inner projections (121) receives the holder (11), while the two projections (121) are just engaged within the grooves (111) of the holder (11) in secure.

The controlling bulb (2) is received in a relating holder (21) having four grooves (211) in cross. The relating socket (22) is provided with four projections (221) at a same position relating to the said four grooves (211). When the controlling bulb (2) and the holder (21) is put inside the socket (22), the four crossed projections (221) are then engaged within the four grooves (211) of the holder (21) that obtains a firm connection. Since the normal bulb (1) has the projection (121) and the grooves (111) at a different position from the controlling bulb (2) has, the controlling bulb (2) is then easy to be identified from the normal bulb and hence it can and only can be received in the relating socket (22) that will be the right position on the light string.

Above all, the character of the present invention is to provide a relating groove and a projection on the holder and the socket to ensure the corrective connection for the controlling bulb or the normal bulb. The said embodiment is just an exemplary to disclose this invention. And any other modification being similar to the present invention will be claimed in the application.

1. An identified structure of a controlling bulb and a normal bulb of a decorative light string, wherein the controlling bulb is received in a holder having several grooves and is then received in a socket having relating projections, while the normal bulb is received in another holder having several grooves and is then received in a relating socket having relating projections; the projections and the grooves on the socket and the socket of the controlling bulb having different positions from those of the normal bulb.
